(19) United States
(12) Patent Application Publication
(10) Pub. No.: US 2013/0175485 A1
(43) Pub. Date: Jul. 11, 2013

(54) ELECTROCONDUCTIVE LIQUID RESIN COMPOSITION AND AN ELECTRONIC PART

(71) Applicant: SHIN-ETSU CHEMICAL CO., LTD., Tokyo (JP)

(72) Inventors: Tatsuya KANAMARU, Karuizawa-machi (JP); Tatsuya UEHARA, Annaka-shi (JP)

(73) Assignee: SHIN-ETSU CHEMICAL CO., LTD., Tokyo (JP)

(21) Appl. No.: 13/715,271

(22) Filed: Dec. 14, 2012

(30) Foreign Application Priority Data
Dec. 28, 2011 (JP) 2011-289594

(51) Int. Cl. H01B 1/02

(52) U.S. Cl. CPC H01B 1/02
USPC 252/514

(57) ABSTRACT

An electroconductive liquid resin composition including epoxy resin; a curing agent, such that an equivalent ratio of the curing agent to the epoxy resin ranges from 0.8 to 1.25, wherein at least one of the components is liquid; a curing promoter in an amount of 0.05 to 10 parts by mass, per total 100 parts by mass of the resin and agent; an electroconductive filler in an amount of 300 to 1,000 parts by mass, per total 100 parts by mass of the resin and agent; and particles of a thermoplastic resin which is solid at 25 degrees C. in an amount of 3 to 50 parts by mass, per total 100 parts by mass of the resin and agent, wherein when the composition is heated, an average diameter of the particles after heated becomes at least one and a half times an average diameter of the particles before heated.

### CROSS REFERENCE

This application claims the benefits of Japanese Patent application No. 2011-289594 filed on Dec. 28, 2011, the contents of which are hereby incorporated by reference.

### FIELD OF THE INVENTION

The present invention relates to an electroconductive paste and provides an electroconductive liquid resin composition which is given a low volume resistivity, i.e., high electroconductivity, by incorporation of a small amount of electroconductive particles, and an electronic part in which this composition is used as an adhesive or a sealing material.

### BACKGROUND OF THE INVENTION

Previously in bonding a semi-conductive tip to a lead frame of a semi-conductive device, a method was effective for high reliability where use is made of a gold-plated lead frame or a small piece of gold tape to form a eutectic crystal. However, this method has been replaced with a method where use is made of an electroconductive paste on account of costs. Usually, electroconductive pastes comprise powder of metal, such as silver, blended with an organic resin as a binder. Recently, semi-conductive tips have become larger and a reflow temperature of solders have become higher, so that enhanced reliability on electroconductive pastes is becoming important.

A large amount of electroconductive particles is added to a resin composition in order to obtain an electroconductive paste having a low volume resistivity. However, a viscosity of such a paste is inevitably high due to the large amount of electroconductive particles added. Then, it is necessary to add a solvent or reactive diluent to the composition to keep the composition in a state of a paste (see the following Patent Literature Nos. 1 and 2). However, due to the added solvent or reactive diluents, mechanical strength, heat resistance or adhesion of its cured product is lower, which is problematic.

Paten Literature No. 1: Japanese Patent Application Laid-Open No. 2010-1330

Paten Literature No. 2: Japanese Patent Application Laid-Open No. 2011-202015

### SUMMARY OF THE INVENTION

An object of the present invention is to provide an electroconductive liquid resin composition which is given a low volume resistivity, i.e., high electroconductivity, by addition of a small amount of electroconductive particles, and which is excellent in heat resistance and adhesion. After keen research to attain the purpose, the present inventors have found a resin composition which is given a low volume resistivity, i.e., high electroconductivity, by incorporation of even a small amount of electroconductive particles is realized, taking advantage of a phenomenon that particles of a thermoplastic resin which are solid at room temperature absorb a liquid epoxy resin and a curing agent upon heating to swell, whereby there occur, in the resin composition, parts with a higher concentration of the resin component and parts with a higher concentration of the electroconductive particles, thus nonuniformity occurs. This finding leads to the present invention.

The present invention is an electroconductive liquid resin composition, comprising

(A) an epoxy resin,

(B) a curing agent in such an amount that an equivalent ratio of an epoxy-reactive group of the curing agent (B) to the epoxy group of the epoxy resin (A) ranges from 0.8 to 1.25,

provided that at least one of the components (A) and (B) is liquid,

(C) a curing promoter in an amount of 0.05 to 10 parts by mass, per total 100 parts by mass of the components (A) and (B),

(D) an electroconductive filler in an amount of 300 to 1,000 parts by mass, per total 100 parts by mass of the components (A) and (B), and

(B) particles of a thermoplastic resin which is solid at 25 degrees C. in an amount of 3 to 50 parts by mass, per total 100 parts by mass of the components (A) and (B),

wherein when the composition is heated, an average particle diameter of component (E) after heated becomes at least one and a half times an average particle diameter of component (B) before heated.

The present invention also provides electronic parts in which this composition is used as an adhesive or a sealing material.

The electroconductive liquid resin composition of the present invention is given a low volume resistivity by the incorporation of a small amount of the electroconductive particles, and is excellent in adhesion to metals such as lead frames. Further, the electroconductive liquid resin composition of the present invention does not contain a solvent or reactive diluent and, therefore, gives electronic parts which are resistant to high humidity and have high adhesion when used as an adhesive or a sealing material. In addition, the electroconductive liquid resin composition of the present invention has a low viscosity and, therefore, is excellent in workability in dispensing and printing, and is suitable as a die bonding material, an adhesive for heat sink, and a lid sealing material.

### BRIEF DESCRIPTION OF THE DRAWINGS

FIG. 1 is a schematic view of the present electroconductive liquid resin composition before heated.

FIG. 2 is a schematic view of the present electroconductive liquid resin composition after heated.

In FIGS. 1 and 2, numeral 1 indicates the particles of the thermoplastic resin before the composition is heated; 2, the epoxy resin, the curing agent, the curing promoter, and the other components; 3, the conductive filler; and 4, the particles of the thermoplastic resin after the composition is heated

FIG. 3 is a chart of DSC on the composition prepared in Example 1.

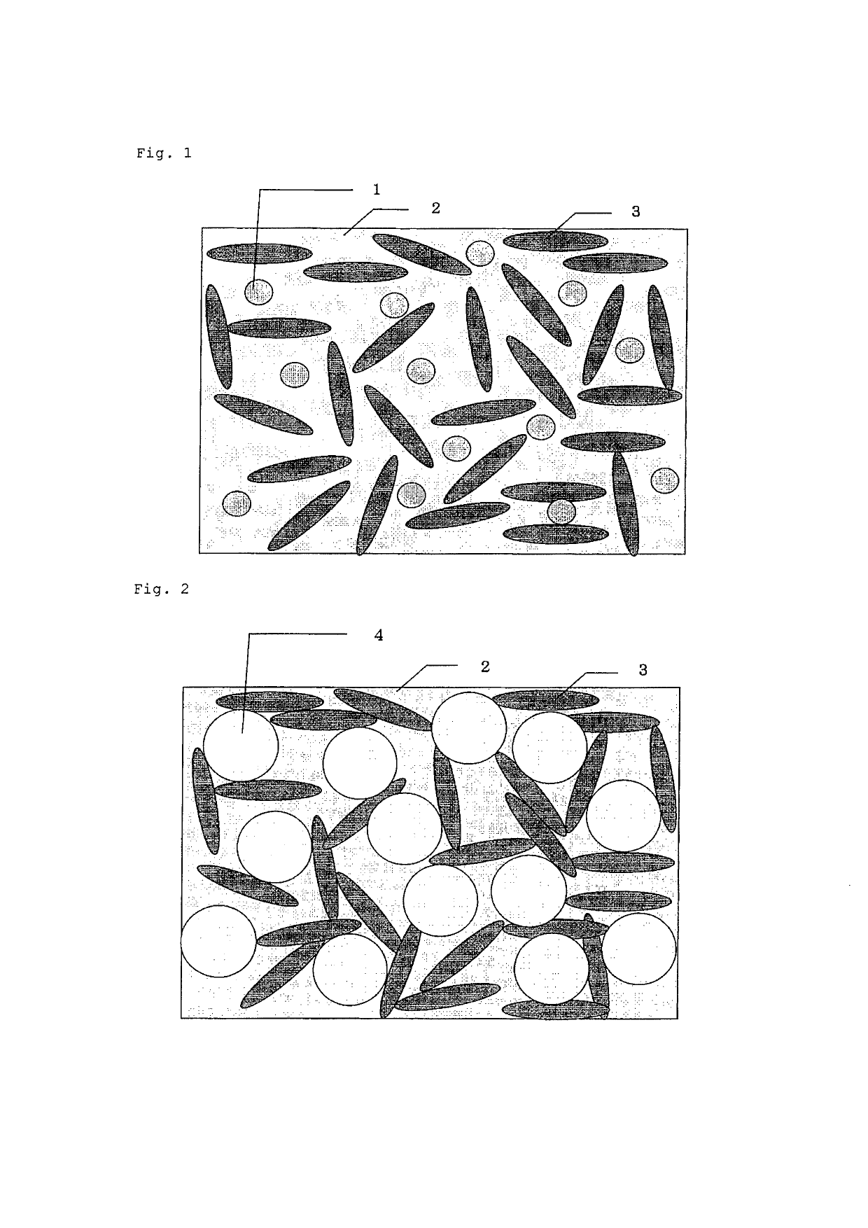

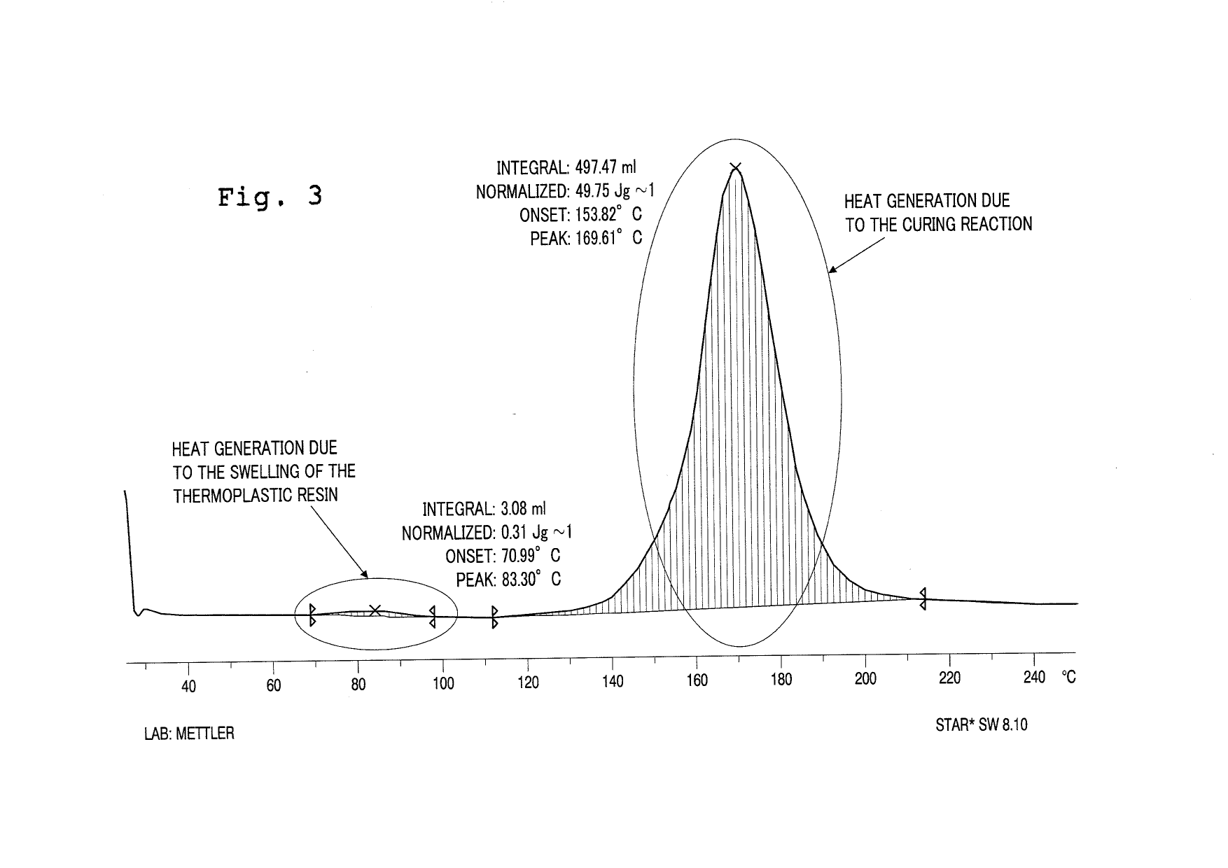

### PREFERRED EMBODIMENTS OF THE INVENTION

First, the components of the present composition will be explained.

(A) Epoxy Resin

Any epoxy resin may be used as long as it has at least two epoxy groups in a molecule. For instance, it may be of a novolac type such as phenol novolac type epoxy resins and cresol novolac type epoxy resins, a bisphenol type such as bisphenol A epoxy resins and bisphenol F epoxy resins, a biphenyl type, a phenolaralkyl type, a dicyclopentadiene type, a naphthalene type, an amino group-containing type, and multi-functional epoxy resins having one aromatic ring such as phenylene ring, and a mixture of these epoxy resins. The epoxy resin may contain silicone-modified epoxy resins. The incorporation of the silicone-modified epoxy resin relaxes stress in a resultant cured product to avoid occurrence of cracks and, further, gives heat impact resistance to semi-conductive devices. Any known silicone-modified epoxy resins may be used. The epoxy resin (A) in the invention is preferably liquid, particularly at 40 to 200 degrees C. Among these, preferred are epoxy resins which are liquid at room temperature (25 degrees C.), such as the bisphenol-A type, the bisphenol-F type, and the multi-functional epoxy resins having one aromatic ring.

The multi-functional epoxy resins having one aromatic ring in a molecule as mentioned above include the following ones.

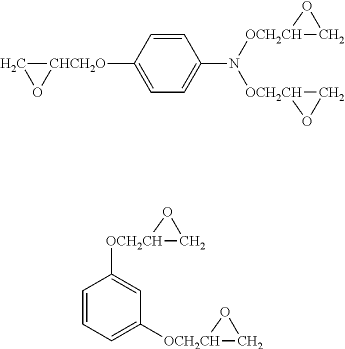

(B) Curing Agent

As the curing agent, any known curing agents for epoxy resins can be used such as phenolic resins, acid anhydrides, and amines. Among these, the phenolic resins are preferred because good balance between curing property and B-stage stability can be attained. Examples of the phenolic resins include ones of a novolac type, a bisphenol type, a trishydroxyphenylmethane type, a naphthalene type, a cyclopentadiene type, and a phenolaralkyl type. These may be used alone or in combination. The curing agent in the invention is preferably liquid, particularly at 40 to 200 degrees C. Among these, preferred are bisphenol type phenolic resins and novolac type phenolic resins which are liquid at room temperature, 25 degrees C. It is required in the invention that at least one of components (A) and (B) is liquid. The present composition may contain silicone-modified phenolic resins. The incorporation of the silicone-modified phenolic resin relaxes stress in a resultant cured product to avoid occurrence of cracks and, further, gives heat impact resistance to semi-conductive devices. Any known silicone-modified phenolic resins may be used.

The amount of the curing agent is such that an equivalent ratio of an epoxy-reactive group (phenolic hydroxy group in the case of the phenolic resin) of the component (B) to the epoxy group of the component (A), i.e., [equivalent of the epoxy-reactive group of the curing agent (B)]/[equilavent of the epoxy group of the component (A)], ranges from 0.8 to 1.25, preferably 0.9 to 1.1. If the equilavent ratio (mole ratio) is less than the lower limit, the unreacted epoxy group remains in a cured product obtained, which might lower a glass transition temperature or worsen adhesion to a substrate. If the equilavent ratio (mole ratio) is larger than the upper limit, a cured product is too hard and brittle, so that cracks might occur in reflow or temperature cycle.

(C) Curing Promoter

The curing promoter may be organic phosphorous compounds, imidazols, or basic organic compounds such as tertiary amines. Examples of the organic phosphorous compounds include triphenylphosphine, tributylphosphine, trip-tolyl) phosphine, tri(p-methoxyphenyl)phosphine, tri(p-ethoxyphenyl)phosphine, triphenylphosphine-triphenylborate derivatives, and tetraphenylphosphine-tetraphenylborate derivatives. Examples of the imidazols include 2-methylimidazol, 2-ethylimidazol, 2-ethyl-4-methylimidazol, 2-phenylimidazol, 2-phenyl-4-methylimidazol, 2-phenyl-4-methyl-5-hydroxymethylimidazol, and 2-phenyl-4,5-dihyroxymethylimidazol. Examples of the tertiary amines include triethylamine, benzyldimethylamine, α-methylbenzyldimethyl amine, and 1,8-diazabicyclo(5, 4, 0) undecene-7.

Among these, tetraphenylphosphine-tetraphenylborate derivatives represented by the following formula (1), or methyrol imidazol derivatives represented by the following formula (2) are preferred:

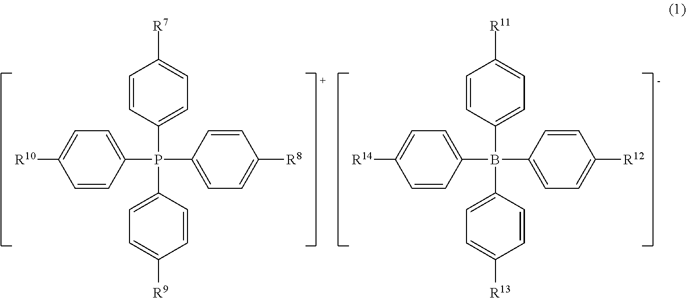

wherein R⁷ to R¹⁴, which may be the same or different, are hydrogen atoms, hydrocarbon groups having 1 to 10 carbon atoms, or halogen atoms;

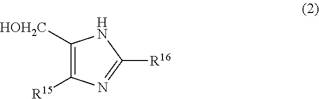

wherein R¹⁵ is a methyl or methylol group, and R¹⁶ is a hydrocarbon group having 1 to 10 carbon atoms.

The curing promoter is incorporated in the composition preferably in an amount of from 0.05 to 10 parts by mass, particularly 0.1 to 5 parts by mass, per total 100 parts by mass of the epoxy resin (A) and the epoxy resin curing agent (B). With an amount of the curing promoter (C) less than the aforesaid lower limit, curing of the composition may be insufficient. If the amount of the curing promoter is larger than the aforesaid upper limit, storage stability of the electroconductive liquid composition may be worse.

(D) Electroconductive Filler

The electroconductive filler may be gold, silver, copper, tin, zinc, nickel, cobalt, iron, manganese, aluminum, molybdenum, and tungsten and alloys thereof, and may be in a form of sphere, particle, flake or needle. Further, it maybe electrically insulating powder, such as silica, alumina, organic resin and silicone rubber, which is surface-coated by vapor deposition or plated with the aforesaid metal. A weight average particle diameter of the filler is desirably 0.1 to 30 μm, particularly 0.5 to 10 μm. The weight average particle diameter is a cumulative mass average diameter, d₅₀, or median diameter in particle diameter distribution determined in a laser light diffraction method.

The amount of the electroconductive filler is 300 to 1,000 parts by mass, particularly 350 to 800 parts by mass, more particularly 400 to 650 parts by mass, per total 100 parts by mass of the components (A) and (B). If the amount is less than the lower limit, electroconductivity is insufficient. If the amount is more than the upper limit, the viscosity of the composition is high so as likely to worsen the workability and, moreover, sometimes obstruct the swelling of component (E), thermoplastic resin particles, described below. The volume resistivity of a cured product is desirably 1×10⁻³ ohm·cm or less, particularly 5×10⁻⁴ ohm·cm or less, at room temperature. The volume resistivity is determined at 25 degrees C. in accordance with the Japanese Society of Rubber Industry Standards (SRIS) 2301.

(E) Particles of a Thermoplastic Resin Solid at 25 degrees C.

The particles of thermoplastic resin which is solid at 25 degrees C. may be publicly known one, such as AAS resins, AES resins, AS resins, ABS resins, MBS resins, vinyl chloride resins, vinyl acetate resins, (meth)acrylic resins, phenoxy resins, polybutadiene resins, various fluoro-resins, various silicone resins, polyacetals, various polyamides, polyamide-imides, polyimides, polyether-imides, polyether ether ketones, polyethylene, polyethylene oxide, polyethylene terephthalate, polycarbonate, polystyrene, polysulfone, polyether sulfone, polyvinyl alcohol, polyvinyl ether, polyvinyl butyral, polyvinyl formal, polyphenylene ether, polyphenylene sulfide, polybutylene terephthalate, polypropylene, and polymethyl pentene, and copolymers thereof. Among these, (meth)acrylic resins, phenoxy resins, polybutadiene resins, polystyrene and copolymers thereof are preferred. The particles may have a core-shell structure where the core and the shell are composed of different resins. Preferably, the core is a rubber particle composed of a silicone resin, a fluororesin, or a polybutadiene resin, and the shell is composed of a thermoplastic resin of liner molecules as described above.

The thermoplastic resin particles may be approximately spherical, cylindrical or rectangular cylinder, amorphous, crushed, or flaky. For a die bonding application, preferred are those of approximately spherical, or amorphous without sharp edges. An average particle diameter of the thermoplastic resin particles is properly selected according to an intended application of the composition. Typically, a maximum particle diameter, i.e., particle diameter at cumulative 98% (d₉₈), is 10 μm or smaller, preferably 5 μm or smaller, and an average particle diameter ranges preferably from 0.1 to 5 μm, more preferably from 0.1 to 2 μm. If a maximum particle diameter is larger than the upper limit or an average particle diameter is larger than the aforesaid upper limit, a part of the thermoplastic resin may not be sufficiently swollen, resulting in a higher volume resistivity of a cured product. On the other hand, if an average particle diameter is smaller than the aforesaid lower limit, the viscosity of the composition is large, sometimes resulting in much worse workability. The average particle diameter of the thermoplastic resin particles herein means a weight average particle diameter. The particle diameter can be determined with an electron microscope or determined as a cumulative weight average diameter, d₅₀, or a median diameter in particle size distribution determined in a laser light diffraction method.

The thermoplastic resin may have a cross-linked structure. However, a degree of the crosslinking is preferably low, because it is desirable that the thermoplastic resin is uniformly dispersed in the network formed by the epoxy resin. More preferably, the thermoplastic resin is of linear polymer chain without cross-linkage.

A molecular weight of the thermoplastic resin particles is properly selected, depending on a type of the resin. Typically, a number average molecular weight, reduced to polystyrene, ranges from 1,000 to 10,000,000, preferably from 10,000 to 100,000, and a weight average molecular weight, reduced to polystyrene, ranges from 10,000 to 100,000,000, preferably from 100,000 to 1,000,000. A thermoplastic resin having a number or weight average molecular weight lower than the aforesaid lower limit may be swollen at a too low temperature, so that the composition might be unstable. On the other hand, a thermoplastic resin having a number or weight average molecular weight higher than the aforesaid upper limit may be swollen at a too high temperature, so that the particles are not be sufficiently swollen, resulting in a high volume resistivity. The average molecular weight, or average polymerization degree, may be determined as a number average value or weight average value, reduced to polystyrene, in GPC, gel permeation chromatography, using toluene, tetrahydrofuran or acetone as a developing solvent.

The amount of the particles of the thermoplastic resin is preferably 3 to 50 parts by mass, more preferably 5-30 parts by mass, much more preferably 10 to 30 parts by mass, per total 100 parts by mass of the components (A) and (B) in order to attain the low volume resistivity. If the amount of the thermoplastic resin is less than the lower limit, it is unlikely that the particles of the thermoplastic resin are sufficiently swollen upon heating. Then, contact among the particles does not develop enough and a low volume resistivity or high conductivity is not attained. If the amount of the thermoplastic resin is larger than the upper limit, it is likely that swelling of the particles of the thermoplastic resin is obstructed, so that contact among the particles does not develop enough and a low volume resistivity or high conductivity is not attained and, further, the viscosity is larger to worsen workability.

One of the characteristics of the present composition is in that when the composition is heated, an average particle diameter of the particles of the thermoplastic resin after heated becomes at least one and a half times, particularly at least twice, an average particle diameter of the particles before heated. The average particle diameter of the particles of the thermoplastic resin after heated is preferably at most four times, more preferably at most three and a half times, the average particle diameter before heated. Upon heating the composition, the particles of the thermoplastic resin in the composition absorb at least one component out of the aforesaid components (A), (B) and (C) to swell. Particularly, when the composition is heated at a temperature in a range of 40 to 200 degrees C. for 1 minute to 3 hours, more particularly at a temperature in a range of 125 to 165 degrees C. for 1 to 3 hours, an average particle diameter of the particles of the thermoplastic resin after heated becomes at least one and a half times, particularly at least twice, an average particle diameter before heated. This heating may be conducted in the same step as in heating for curing the composition or heating for conversion to B stage, or in another step. The average particle diameter of the particles of the thermoplastic resin after heated may be determined by observation on the surface of the cured product by an electron microscopy. A swelling property of the aforesaid component (E) depends upon a molecular weight and dispersion of the particles of the thermoplastic resin, an amount of component (E) and an amount of component (D). A proper combination of these parameters may be properly set so as to have the average particle diameter after heated meet the aforesaid condition. Particularly, a total of the amounts of components (E) and (D) is 700 parts by mass or less, more preferably 300 to 700 parts by mass, per 100 parts by mass of a total of the amounts of components (A) and (B) for securing the swelling property of component (E).

(F) Other Components

In addition to the aforesaid components, a silane coupling agent, a flame retardant, an ion-trapping agent, wax, a colorant and an adhesion aid may be incorporated in the present composition as far as the purposes of the invention are not interrupted to attain.

Examples of the silane coupling agent include γ-glycidoxypropyltrimethoxysilane, γ-glycidoxypropylmethyldiethoxysilane, γ-glycidoxypropyltriethoxysilane, p-styryltrimethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-β(aminoethyl)γ-aminopropylmethyldimethoxysilane, N-β(aminoethyl)γ-aminopropyltrimethoxysilane, N-β(aminoethyl)γ-aminopropyltriethoxysilane, γ-aminopropyltrimethoxysilane, γ-aminopropyltriethoxysilane, N-phenyl-γ-aminopropyltrimethoxysilane, γ-mercaptopropylmethyldimethoxysilane, γ-mercaptopropyltrimethoxysilane, bis(triethoxypropyl)tetrasulfide, and γ-isocyanate propyltriethoxysilane. These can be used alone or in a mixture of two or more of these. Among these, γ-glycidoxypropyltrimethoxysilane is preferred. When the aforesaid coupling agent is used, this is incorporated in the composition usually in an amount of from 0.1 to 5.0 parts by mass, preferably from 0.3 to 3.0 parts by mass, per total 100 parts by mass of the components (A) and (B).

Preparation of the Electroconductive Composition

The present electroconductive resin composition can be prepared by mixing the aforesaid components with any publicly known mixing means such as a mixer, and a roller mill. When the present electroconductive resin composition is applied on a substrate, for instance, with a thickness of 5 to 200 μm, this can be converted into a B stage by heating at 60 to 200 degrees S, preferably 40 to 150 degrees C., for 1 minute to 3 hours, preferably 10 minutes to 1 hour.

The present electroconductive composition preferably has a viscosity of 10 to 500 Pa·s, more preferably 30 to 400 Pa·s, as determined at 25 degrees C. with an E type viscometer. If the viscosity is larger than the aforesaid upper limit, wettability between the electroconductive resin composition and a substrate is worse to cause voids and poor adhesion. If the viscosity is smaller than the aforesaid lower limit, tackiness occurs at room temperature, so that, when the composition is used as a die bonding material, release from a dicing tape tends to worsen, which is undesirable.

The present electroconductive resin composition may be used as an adhesive or a sealing material for various electronic parts, for instance as a die bonding material, an adhesive for heat sinks, and a lid sealing material. The use may be conducted by any conventional method or apparatus. Typical curing conditions include a temperature of 100 to 200 degrees C., preferably 120 to 180 degrees C., for a period of time of 1 to 8 hours, preferably 1.5 to 3 hours. the curing of the electroconductive resin composition may be conducted simultaneously in a step of resin encapsulation of a semi-conductive device.

### EXAMPLES

The present invention will be explained in more detail with reference to the non-limitative Examples.

### Examples 1-3 and Comparative Examples 1-6

The following components were blended in the amounts shown in Table 1 and mixed by a planetary mixer at 25 degrees C., passed through a three-roller mill at 25 degrees C., and mixed again by a planetary mixer at 25 degrees C. to obtain a composition,

Materials Used

(A) Epoxy Resin

Bisphenol-F type epoxy resin having an epoxy equivalent of 160, liquid (viscosity of 1.5 Pa·s) at room temperature (25 degrees C.), sold under the trade name “YDF-8170C” from Shin-Nippon Chemical, Co., Ltd.

(B) Curing Agent

Liquid phenol novolac resin having a phenol equivalent of 141, liquid (viscosity of 2.5 Pa·s) at room temperature (25 degrees C.), sold under the trade name “MEH-8000H” from Meiwa Plastic Industries, Ltd.

(C) Curing Promoter

2-Phenyl-4-methyl-5-hidroxyimidazol, sold under the trade name “2E4MHZ-PW from Shikoku Kasei Co. Ltd.

(D) Electroconductive Filler

Flaky silver powder with a weight average diameter of 6.1 μm, sold under the trade name “AgC-237” from Fukuda Kinzoku Hakufun Industry Co. Ltd.

(E) Thermoplastic Resin Particles

Poly(methyl methacrylate) having a number average molecular weight of 50,000, a weight average molecular weight of 150,000, an average particle diameter of 1 μm and a maximum particle diameter, d₉₉, of 3 μm.

Silicone powder with an average diameter of 2 μm and a maximum diameter, d₉₉, of 5 μm, sold under the trade name “KMP-605”, ex Shin-Etsu Chemical Co. Ltd.

(F) Other Components

Silane coupling agent: KBM403, ex Shin-Etsu Chemical Co. Ltd.

Solvent: diethyleneglycol monomethyl ether, “EDGAC”, ex. Dicel Co. Ltd.

Reactive diluent: polyethyleneglycol diglycidylether with an epoxy equivalent of 268, liquid (viscosity, 0.07 Pa·s) at room temperature (25 degrees C.), “Denacol EX830”, ex. Nagase Chemtec.

Each composition was subjected to the following tests. The results are as shown in Table 1.

Test Methods

(a) Viscosity

A viscosity of the composition was measured by an E-type viscometer, HBDV-III, ex Brookfield Co., at a temperature of 25 degrees C and a shear rate of 2.00 sec⁻¹ according to the Japanese Industrial Standards (JIS) Z-8803. Measurement was made 2 minutes after start of rotation.

(b) Volume Resistivity of a Cured Product

A volume resistivity was measured on a cured product of each composition at 25 degrees C. in accordance with the Japanese Society of Rubber Industry Standards (SKIS) 2301.

(c) Adhesion

Each composition was put in a form of a truncated cone having a diameter of a top face of 2 mm, a diameter of a bottom surface of 5 mm and a height of 3 mm on s silicone tip (called substrate A), a copper plate (called substrate B) and a 42 alloy (called substrate C), heated at 125 degrees C. for one hour and, then, 165 degrees C. for 2 hours to cure. Each five test pieces were prepared for each composition. A shear adhesion strength was determined on each test piece after cured, which was called an initial value. Further, each test piece was left in a vessel kept at a constant temperature of 85 degrees C. and a constant humidity of 85% RH, for 168 hours, and put through an IR reflow oven with a maximum temperature of 260 degrees C. three times, called a high temperature and high humidity test, and subjected to measurement of adhesion strength. The values shown in Table 1 is an average from five test pieces. A shear adhesion strength was determined by Multipurpose Bondtester Series 4000, ex DAGE.

(d) Swellability of the Thermoplastic Resin

Each resin composition was casted in a mold of 15 mm by 5 mm by 5 mm, heated at 125 degrees C. for one hour, and at 165 degrees C. for 2 hours to cure. A hundred points on the cure product were observed at random with magnification of 2,000 by electron microscope VE-8800, ex KEYENCE. An average of a major axis and a minor axis of each particle is called a size, or, average diameter, of the thermoplastic resin. An average of the 100 values from the 100 observed points is called an average particle diameter of the thermoplastic resin particles.

The swellability is calculated by the following equation.

Swellability=(average particle diameter of the thermoplastic resin particles after heat cured)/(average particle diameter of the thermoplastic resin particles before blended in the resin composition)

| | | Example | | | Comparative Example | | | | | |
|---|---|---|---|---|---|---|---|---|---|---|
| Composition, part by mass | | 1 | 2 | 3 | 1 | 2 | 3 | 4 | 5 | 6 |
| (A) Epoxy resin | YDF-8170C | 53.2 | 53.2 | 53.2 | 53.2 | 53.2 | 53.2 | 53.2 | 53.2 | 36.9 |
| (B) Curing agent | MEH-8000H | 46.8 | 46.8 | 46.8 | 46.8 | 46.8 | 46.8 | 46.8 | 46.8 | 43.1 |
| (C) Curing promoter | 2E4MHZ-PW | 1 | 1 | 1 | 1 | 1 | 1 | 1 | 1 | 1 |
| (D) Electroconductive | AgC-237 | 450 | 530 | 650 | 250 | 650 | 450 | 450 | 700 | 700 |
| filler | | | | | | | | | | |
| (E) Thermoplastic Resin | Methyl polymethacrylate | 10 | 30 | 10 | 10 | 60 | | | | |
| | KMP605 | | | | | | 10 | | | |
| Silane coupling agent | KBM-403 | 1 | 1 | 1 | 1 | 1 | 1 | 1 | 1 | 1 |
| Solvent | EDGAC | | | | | | | | 20 | |
| Reactive diluent | Denacol EX830 | | | | | | | | | 20 |
| Evaluated property | (a) Viscosity, Pa · s | 40 | 200 | 320 | 20 | 800 | 40 | 30 | 50 | 140 |
| | (b) Volume resistivity, 10⁻³ Ω · cm | 0.3 | 0.2 | 0.04 | 1000 | 5 | 10 | 20 | 0.1 | 0.3 |
| | (c) Adhesion strength, initial value, silicone tip, MPa | 12 | 10 | 10 | 12 | 6 | 9 | 12 | 6 | 9 |
| | (c) Adhesion strength, initial value, copper plate, MPa | 11 | 10 | 9 | 12 | 5 | 8 | 10 | 5 | 9 |
| | (c) Adhesion strength, initial value, 42 alloy, MPa | 9 | 8 | 8 | 10 | 5 | 9 | 9 | 4 | 6 |
| | (C) Adhesion strength, after deterioration, | 12 | 10 | 10 | 12 | 4 | 9 | 9 | 4 | 5 |
| | silicone tip, MPa | | | | | | | | | |
| | (C) Adhesion strength, after deterioration, | 11 | 9 | 8 | 11 | 4 | 7 | 8 | 4 | 3 |
| | copper plate, MPa | | | | | | | | | |
| | (C) Adhesion strength, after deterioration, | 9 | 7 | 7 | 9 | 4 | 9 | 6 | 3 | 2 |
| | 42 alloy, MPa | | | | | | | | | |
| | (d) Swellability of the thermoplastic resin | 3.1 | 2.2 | 2.8 | 3.7 | 1.4 | 1.1 | — | — | — |

As seen in Table 1, the cured product obtained from the composition of Comparative Example 4 which did not contain the thermoplastic resin had the high volume resistivity. The cured product from the composition of Comparative Example 5 which did not contain the thermoplastic resin and contained the solvent and the cured product obtained from the composition of Comparative Example 6 which did not contain the thermoplastic resin and contained the reactive solvent had the low volume resistivities, but had the poor heat resistance and the poor adhesion. The cured product from the composition of Comparative Example 3 in which the average particle diameter of the thermoplastic resin after heated was less than the 1.5 times the average particle diameter of the thermoplastic resin before heated had the high volume resistivity. In Comparative Example 1, the amount of the conductive filler was too small, so that volume resistivity of the cured product was high. In Comparative Example 2, the amounts of the conductive filler and the thermoplastic resin were too large, so that the viscosities were high, and the thermoplastic resin did not swell enough and, therefore, the volume resistivities were high. In contrast, the present resin compositions were of the low viscosities, and gave the low volume resistivities even with the low amounts of the conductive filler incorporated. Further, the present resin compositions were excellent in resistance against the high temperature and high humidity, and showed the good adhesion even after the high temperature and high humidity test.

Differential Scanning Calorimetry

The composition of Example 1 was subjected to DEC at the temperature rise rate of 10 degrees C./min. in the temperature range of 25 to 250 degrees C. with DSC821e, ex METTLER TOLEDO. The obtained data are as shown in FIG. 3. As seen in FIG. 3, generation of heat on account of the swelling of the thermoplastic resin appears before the generation of heat on account of the curing reaction. This proves that the thermoplastic resin swells upon heating.

### INDUSTRIAL APPLICABILITY

The electroconductive liquid resin composition of the present invention is given a low volume resistivity by the incorporation of a small amount of the electroconductive particles. In addition, the electroconductive liquid resin composition of the present invention has a low viscosity and, therefore, is suitable as a die bonding material, an adhesive for heat sinks, and a lid sealing material. Further, the electroconductive liquid resin composition of the present invention does not contain a solvent or reactive diluent and further is excellent in resistance against a high temperature and high humidity and, therefore, gives electronic parts which are resistant to high humidity and have high adhesion when used as an adhesive or a sealing material.

1. An electroconductive liquid resin composition, comprising
(A) an epoxy resin,
(B) a curing agent in such an amount that an equivalent ratio of an epoxy-reactive group of the curing agent (B) to the epoxy group of the epoxy resin (A) ranges from 0.8 to 1.25,
provided that at least one of the components (A) and (B) is liquid,
(C) a curing promoter in an amount of 0.05 to 10 parts by mass, per total 100 parts by mass of the components (A) and (B),
(D) an electroconductive filler in an amount of 300 to 1,000 parts by mass, per total 100 parts by mass of the components (A) and (B), and
(E) particles of a thermoplastic resin which is solid at 25 degrees C. in an amount of 3 to 50 parts by mass, per total 100 parts by mass of the components (A) and (B),
wherein when said composition is heated, an average particle diameter of said component (E) after heated becomes at least one and a half times an average particle diameter of said component (E) before heated.

2. The electroconductive liquid resin composition according to claim 1, wherein component (E) is particles of at least one thermoplastic resin selected from (meth)acrylic resins, phenoxy resins, polybutadiene resins, polystyrenes and copolymers thereof

3. The electroconductive liquid resin composition according to claim 1, wherein component (E) has a number average molecular weight, reduced to polystyrene, ranges from 1,000 to 10,000,000, and a weight average molecular weight, reduced to polystyrene, ranges from 10,000 to 100,000,000.

4. The electroconductive liquid resin composition according to claim 1, wherein the electroconductive resin composition has a viscosity of 10 to 500 Pa·s, as determined at 25 degrees C. with an E type viscometer.

5. The electroconductive liquid resin composition according to claim 1, wherein a total of the amounts of components (E) and (D) is 700 parts by mass or less per 100 parts by mass of a total of the amounts of components (A) and (B).

6. The electroconductive liquid resin composition according to claim 1, wherein when the composition is heated at a temperature in a range of 40 to 200 degrees C. for 1 minute to 3 hours, an average particle diameter of component (E) after heated becomes at least one and a half times an average particle diameter before heated.

7. The electroconductive liquid resin composition according to claim 1, wherein the composition gives a cured product having a volume resistivity of 1×10⁻³ ohm·cm or less, as determined at 25 degrees C. in accordance with the Japanese Society of Rubber Industry Standards (SRIS) 2301.

8. An electronic part provided with the electroconductive liquid resin composition according to claim 1 as an adhesive or a sealing material.
